(19) United States
(12) Patent Application Publication
(10) Pub. No.: US 2007/0280657 A1
(43) Pub. Date: Dec. 6, 2007

(54) Baby bottle/food warmer

(76) Inventor: Jennifer Loia, Hopewell Junction, NY (US)

Correspondence Address: SUNG I. OH, PROFESSIONAL LAW CORPORATION, 710 QUAIL VALLEY LANE, WEST COVINA, CA, 91791, US

(21) Appl. No.: 11/444,267

(22) Filed: May 31, 2006

(51) Int. Cl. A47J 31/54

(52) U.S. Cl. 392/442

(57) ABSTRACT

A baby bottle/food heating system includes means for permitting the simultaneous heating of at least two bottles and a timer mechanism that automatically shuts off a heater element of the system after a pre-set time.

### TECHNICAL FIELD OF THE INVENTION

The present invention relates to the general art of liquid containers, and to the particular field of infant and baby bottles.

### BACKGROUND OF THE INVENTION

Based upon the fact that the temperature of mother's milk is approximately 37E C., it has been recognized that milk/formula given to the unweaned should be at approximately this temperature. Liquid above or below this temperature may be rejected by the baby. If the liquid is accepted and is too hot, the baby's lips and mouth may be burned. If the liquid is too cold, it may bring a case of indigestion.

Baby-food formulations may be prepared from a suitable volume of either liquid or powdered nutriment, mixed with a measured quantity of a carrier liquid such as water. As mentioned above, the resulting liquid is heated to body temperature on the order of 98.6E F. for consumption by an infant through a nipple-equipped bottle. Although the formulation can be prepared in a number of ways, it is convenient to prepare the beverage directly in a dispensing bottle using a bottle warmer.

In the past, the most common method for determining the temperature of the liquid was simply the tactile feeling of the fingertip or the hand palm of a person having access to the feeding bottle. The determination was therefore often reliable as it simply depended upon the thermal feeling of a particular person having access to the feeding bottle and furthermore was not free from the influences of atmospheric or room temperature.

A feeding schedule for a baby typically includes feeding intervals between a minimum of about three hours and a maximum of about four hours. The majority of babies generally adapt to this schedule within a few weeks.

Naturally, the schedule intervals may be shifted to those most convenient for the parents. However, no matter what the schedule, night-time feeding is mandated by the baby's needs.

Most parents find it most convenient to prepare enough formula for a full day's feeding simply because it is easier at late night or early morning hours to simply heat a prepared bottle to avoid the late night/early morning steps of boiling the bottles for sterilization and thereafter filling the bottles with formula.

While the inventor is aware of several temperature indicating baby bottle designs, none of the designs known to the inventor are capable of heating plural baby bottles and most are complicated or produce unreliable results. If a parent of twins is preparing formula, several bottles must be prepared. The bottles should not be prepared one-by-one for many reasons.

Therefore, there is a need for a device that will reliably and accurately heat a plurality of baby bottles to a desired temperature.

### SUMMARY OF THE INVENTION

The above-discussed disadvantages of the prior art are overcome by a baby bottle heating system in which at least two bottles can be heated simultaneously and which has a timer mechanism that automatically shuts off a heater element of the system after a pre-set time.

Using the baby bottle heating system embodying the present invention will permit simultaneous heating of plural bottles which can contain infant formula or the like and have that heating automatically controlled to cease after a preset time period so the liquid will be heated to a desired temperature without the need of manual testing. The automatic heating will allow a parent to comfort an infant while waiting for the liquid to heat. This will reduce stress on both the infant and the care giver.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a baby bottle heating system embodying the present invention.

FIG. 2 is a front elevational view of the system shown in FIG. 1.

FIG. 3 is a top plan view of the system shown in FIG. 1.

FIG. 4 is a perspective view of a basket that can contain jars and off-size liquid containers so those containers can be heated in the system embodying the present invention.

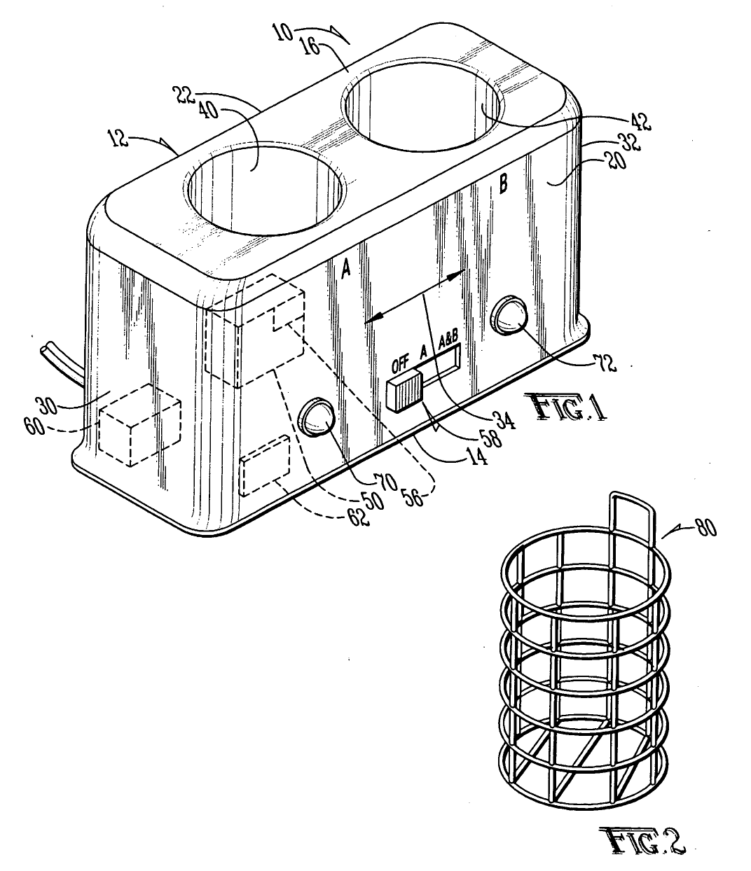

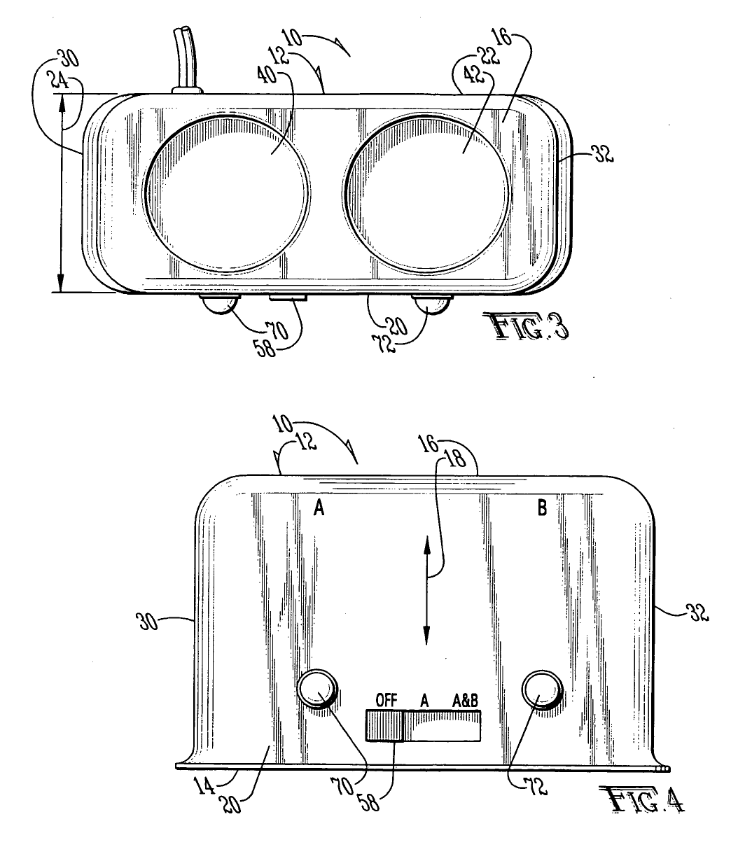

### DETAILED DESCRIPTION OF THE INVENTION

Referring to the figures, it can be understood that the present invention is embodied in a baby bottle/food heating system 10 which embodies the present invention. System 10 comprises a bottle-holding base 12 which includes a first surface 14 which is a bottom surface when the base is in use, a second surface 16 which is a top surface when the base is in use and a height axis 18 which extends between first surface 14 and second surface 16.

A first side wall 20 extends between first surface 14 and second surface 16, and a second side wall 22 extends between the first surface and the second surface. A width dimension 24 extends between first side wall 20 and second side wall 22. Housing 12 further includes a first end wall 30 which extends between first surface 14 and second surface 16, a second end wall 32 which extends between the first surface and the second surface and a length dimension 34 which extends between first end wall 30 and second end wall 32.

First and second tubular blind-ended bores 40 and 42 are defined in the housing and extend from second surface 16 toward first surface 14 in the direction of height axis 18. Bores 40 and 42 are spaced apart from each other in the direction of length dimension 34 of the housing. An electric heating unit 50 is located in the housing. Heating unit 50 is in thermal contact with the housing adjacent to the blind-ended bores so that heat generated by the heating unit is transferred into the bores. The particular form of the heating unit and the exact details thereof are not important to the present invention and the particular form and details of the heating unit will not be claimed. As such, the particular form and details of heating unit 50 will not be presented. A heating unit control system 56 is located in the housing and includes a power cord 60 which is adapted to be connected to a source of power, such as utility power via an electrical outlet in a user's home.

System 56 further includes a multi-position on/off switch 58 electrically connected to the power cord. The on/off switch 58 is electrically connected to the heating unit to activate the heating unit adjacent to either bore 40 or adjacent to bore 42 or both depending on the physical position of the switch. Thus, multi-position on/off switch 58 is electrically connected to the power cord and to the heating unit adjacent to each blind-ended bore to control the heating unit associated with each blind-ended bore separately to turn on the heating unit associated with first blind-ended bore 40 independently of the heating unit associated with second blind-ended bore 42 when the switch is in a first position and vice versa when the switch is in a second position and to turn the heating units associated with both the first and second blind-ended bores on simultaneously when the switch is in a third position.

Several parallel circuits can be used to electrically interconnect the on/off switch to the heating elements of system 50 as will be understood by those skilled in the art. As such, the exact details of the circuitry associated with the on/off switch will not be disclosed. A timer unit 60 electrically connects the power cord to the heating unit via the on/off switch. Timer unit 60 includes circuitry 62 for automatically disconnecting the power cord from the heating unit after a preset time. The details of the timer circuit are well known to those skilled in the art and will not be discussed or claimed.

A first indicator light 70 is located on the first side of the housing adjacent to the first tubular blind-ended bore and is electrically connected to the electric heating unit associated with the first tubular blind-ended bore to be activated when power is applied to the electric heating unit associated with the first tubular blind-ended bore. Indicator light 70 is de-activated when the timer shuts off the heater associated with the first bore.

A second indicator light 72 is located on the first side of the housing adjacent to the second tubular blind-ended bore and electrically connected to the electric heating unit associated with the second tubular blind-ended bore to be activated when power is applied to the electric heating unit associated with the second tubular blind-ended bore. Indicator light 72 is de-activated when the timer shuts off the heater associated with the second bore. A tubular basket 80 is sized to be accommodated in a tubular blind-ended bore to hold small containers in the bore for heating.

Use of system 10 will be understood from the teaching of this disclosure and as such will only be briefly discussed. If one baby bottle is to be heated, it can be placed in either bore 40 or bore 42 and the on/off switch moved to the appropriate position. Heat will be applied to the baby bottle for a preset time during which the indicator light associated with the bore will be activated. On the other hand, two bottles can be warmed simultaneously by placing one bottle (or container using basket 80) in each bore, and moving the on/off switch to the appropriate location. Both indicator lights will be activated during the heating of the bottles and will be de-activated when the timer disconnects power from the heater units.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A baby bottle/food heating system comprising:
A) a bottle-holding base which includes
(1) a first surface which is a bottom surface when the base is in use,
(2) a second surface which is a top surface when the base is in use,
(3) a height axis which extends between the first surface and the second surface,
(4) a first side wall which extends between the first surface and the second surface,
(5) a second side wall which extends between the first surface and the second surface,
(6) a width dimension which extends between the first side wall and the second side wall,
(7) a first end wall which extends between the first surface and the second surface,
(8) a second end wall which extends between the first surface and the second surface,
(9) a length dimension which extends between the first end wall and the second end wall, and
(10) first and second tubular blind-ended bores defined in the housing and extending from the second surface toward the first surface in the direction of the height axis, the bores being spaced apart from each other in the direction of the length dimension of the housing;
B) an electric heating unit in the housing, the heating unit being in thermal contact with the housing adjacent to the blind-ended bores so that heat generated by the heating unit is transferred into the bores;
C) a heating unit control system in the housing and including
(1) a power cord which is adapted to be connected to a source of power, such as utility power,
(2) a multi-position on/off switch electrically connected to the power cord, the on/off switch being electrically connected to the heating unit adjacent to each blind-ended bore to control the heating unit associated with each blind-ended bore separately to turn on the heating unit associated with the first blind-ended bore independently of the heating unit associated with the second blind-ended bore when the switch is in a first position and vice versa when the switch is in a second position and to turn the heating units associated with both the first and second blind-ended bores on simultaneously when the switch is in a third position,
(3) a timer unit electrically connecting the power cord to the heating unit via the on/off switch, the timer unit including circuitry for automatically disconnecting the power cord from the heating unit after a preset time, and
(4) a first indicator light on the first side of the housing adjacent to the first tubular blind-ended bore and electrically connected to the electric heating unit associated with the first tubular blind-ended bore to be activated when power is applied to the electric heating unit associated with the first tubular blind-ended bore, and
(5) a second indicator light on the first side of the housing adjacent to the second tubular blind-ended bore and electrically connected to the electric heating unit associated with the second tubular blind-ended bore to be activated when power is applied to the electric heating unit associated with the second tubular blind-ended bore; and
C) a tubular basket sized to be accommodated in a tubular blind-ended bore.

2. A baby bottle/food heating system comprising:
A) a body having a heating element therein and two individual bores defined therein, the body adjacent to the bores being in thermal contact with the heating element to receive heat therefrom; and
B) a heating element control which includes a timer mechanism which automatically turns off the heating element after a pre-set time.
